(19) United States
(12) Patent Application Publication
(10) Pub. No.: US 2007/0282845 A1
(43) Pub. Date: Dec. 6, 2007

(54) Intentional Addressing and Resource Query in a Data Network

(76) Inventor: Kurt Seljeseth, Borgen (NO)

Correspondence Address: LADAS & PARRY, 26 WEST 61ST STREET, NEW YORK, NY, 10023, US

(21) Appl. No.: 10/582,185

(22) PCT Filed: Dec. 10, 2004
(86) PCT No.: PCT/NO04/00383

§ 371 Date: May 8, 2007

(30) Foreign Application Priority Data
Dec. 10, 2003 (NO) 20035503

(51) Int. Cl. G06F 17/30

(52) U.S. Cl. 707/10; 707/E17.032

(57) ABSTRACT

In a method and a system for arriving quickly at desired resources in a data network, a user states a resource query in rich language in a first line user interface attached to the data network. At least one layer for dynamic communication and handling, implemented at a network context operator, then processes the resource query and uncovers the intention of the user, through processing in accordance with for instance user specific information and special handling algorithms. Thereafter, the layer establishes a connection to the specific address of the resource in question.

The present patent application relates to a method and a system for rapid provision of desired resources for users in a data network. “Resource” is here intended to mean in general something or someone to be used as a source for help or information, but in an ordinary case, a resource may be for instance a certain information page in a web service based hierarchy of such pages.

Existing addresses—information describing where somebody or something is located—in electronic networks are today based essentially on unique identifiers that are necessary for handling channel-technical aspects inter alia while establishing communication, with corresponding address expressions—the address such as is to be read explicitly—also towards the users. (“Network” shall in general be taken to mean at least two, usually several computers, terminals and communication units interconnected by means of wires, cables or a telecommunication system, arranged for the purpose of exchanging information.)

Typically, for instance a query address for a resource in a telephone network—a “resource” being someone or something that can be used as a source for help or information—and for establishing communication between two telephone terminals, will consist of a unique collection of numbers, commonly known as a telephone number.

In larger network contexts (i.e. assumptions, conditions and factors constituting and influencing an environment or a function area associated with electronic networks, in which, thereby, something exists or occurs), telephone number series belonging to a country receive an additional country code which is numerical also.

Telephone numbers typically have an address and an address expression such as follows:

00 47 12345678

Correspondingly, an address that is necessary for a query for a resource on the World Wide Web (www) will state, among other things, technical aspects for a superior network context, together with a unique domain name and possibly also a unique resource localization path within the network context of the domain.

A domain name is taken to mean a succession of words, phrases, abbreviations or characters that identify a computer or a network in the internet, and which has the function of an address thereof.

A domain is taken to mean a range of either activities or sets of resources that someone or something has an influence on.

A www address consists typically of a collection of letters, characters and numerals, and is strictly logical, and substantially qualitatively meaningful only to the machines and software attached exclusively to the network (and in this case also the network channel—www).

Quality is taken to mean a property or characteristic that identifies or indicates main concerns and possibly also essential features of someone or something.

Typically, a www resource has an address as given in the following: http://www.bonzzo.com/nor/servpool/neserv/flizzfl.htm

A network channel is taken to mean a frequency spectrum, a medium or means for handling similar type of information in connection with networks—in this case electronic networks.

For instance, www and Wireless Application Protocol (WAP) are two network channels within the network channel Hyper Text Transfer Protocol (HTTP) that is superior to them.

Naturally, the complexity of such unique addresses will be increasing in accordance with the constantly increasing resource hierarchies (sets of resources arranged formally or logically relative to each other or other resources) of the information society and associated with electronic networks, both at a micro-level, for instance in a domain or a telephone exchange, and at a macro-level, for instance in the DNS system, with regard to network contexts.

The complexity of network addresses and their need of exclusivity relative to own network context, represent, considering similar or identical address expressions, a challenge both to users and operators, particularly with regard to address competence and resource handling demands.

A user shall be taken to mean a person or entity that uses something—in this case associated with electronic networks.

An operator shall be taken to mean a person or entity with influence on someone or something. In the data network terminology, often an owner/manager of a server station, or an entity having control of such a station, and with the ability to offer resources to users.

Address competence is taken to mean the knowledge that is necessary for establishing an address.

A development with constantly more resources to be made available in electronic networks, will naturally result in more addresses and more lengthy addresses, which will naturally raise the demand for address competence with users, and it will become more difficult for users both to remember addresses in general, and even finding addresses, specifically, valid for one resource among an increasing abundance of other resources.

Numerous mechanisms, products and services seek to assist users of electronic networks with the problem approach of both having to remember and also possibly find the unique and complex addresses that are necessary to establish communication and delivery of resource in accordance with the user's intention. (“Mechanism” shall be taken to mean, in general, a complete machine or parts thereof, a machine-based service, method or facility/means for executing a certain task.)

The directory of a telephone terminal, where a user finds a desired resource from a “pre-programmed” list, and initiates a conversation by making the telephone call a telephone number associated with the selected name, is such a mechanism that assists the user in “remembering” unique and complex addresses.

The option of bookmarking addresses historically in browsers for www and WAP network channels, is another mechanism for the same purpose.

Some products and services offer assistance with “finding” unique addresses, with a background in the user's stated intention regarding an electronic address or provision of a technically adapted shortcut in a network (for instance a hypertext link).

One example of such a “find” service is a so-called “manual” information service in which a user establishes communication using a unique address toward a dedicated resource (i.e. a resource with special focusing useful for one special purpose), in order to, for instance through a conversation with a professional staff member, there hunting out and having read, getting connected to and/or having transmitted a unique network address to the (finally) intended resource.

An intended resource shall be taken to mean a resource that a user ultimately—finally—desires to reach in accordance with intention.

One product that offers “find” assistance, is typically distributed catalogues containing similar resource and address information with a basis in previous editorial treatment.

Dedicated electronic network resources offer similar services to their users, where the professional staff member is replaced by offers for various search aids and mechanisms in which the user himself inquires, there to state his own intention regarding an intended resource. Search engines in the internet are typically such a dedicated network resource, compare for instance www.alltheweb.com and www.yahoo.com.

Among the commonly most used mechanisms for finding resources in complex resource hierarchies, are adapted user interfaces and resources, for instance the first offered page (typically “front page” named index) and further attached sub-pages in a graphically adapted information service within www and WAP, which through the hypertext principle offers for the user the procedure of clicking on adapted “shortcuts” further on to the next resource, and in this manner the user navigates on to the ultimately intended resource.

A user interface shall be taken to mean the (visual, tactile, audible) frame of operation established by software and that accepts commands from the user and returns information to the user.

A common feature for all these mechanisms, products and services is that assistance or added value relative to the user's intention about delivery of an intended resource, requires exact address competence in a first line user interface. Only ahead of the first line user interface or in later user interfaces, possibly also in the form of operations executed historically before or later or in an external mechanism, product or service during the user session, these mechanisms, products and services will be able to establish delivery of a resource with a background in richly expressed and/or qualitative addresses as well as queries for delivery of a resource in accordance with the explicitly stated intention of the user.

“Richly expressed” shall be taken to mean expression forms that contain elements carrying a meaning about somebody or something by further remark, intention or specification than merely the absolutely necessary minimum for communication—technically or inter-humanly qualified. Examples of rich expressions may be “the front page of vg.no”, or “I bid you farewell”, where respectively “vg.no” (technically qualified) or “farewell” (inter-humanly qualified in a natural context) would be sufficient.

Qualitative addresses may inter alia be expressed in normal or approximately normal language, completely or partly, for instance in accordance with name, subject, content, characteristics, tasks and/or areas of responsibility for a person, role, firm, product, service and/or other resources.

Three examples of a richly expressed and qualitative address are the following:

products.from.bonzzo.com

Bonzzo Customer Service in Norway

The marketing manager of Bonzzo in USA

A first line user interface shall be taken to mean the user interface first used by the user in active user connection and query for a resource toward electronic network context.

Two examples of first line user interfaces are the user interface in which the user keys numbers for telecommunication, and the address line in which the user keys in addresses for query for resources associated with the internet.

In concrete words, this means that in the prior art, a user can not state a query for an intended resource, containing for instance “motor specifications for the car make Corvette” as an address statement directly in the first line user interface according to intention. The address statement could then have been:

Motor specifications for Corvette

In today's art, a user must first establish communication toward a dedicated resource through the use of a unique address, for instance a telephone number to a directory inquiry service, a distributor or a manufacturer, or an internet address to a search service—thereafter to query an intended resource, before possible further delivery of resources—finally the intended resource.

Resource hierarchy operators experience problems partially similar to what users experience—however naturally on a much larger scale, and partly associated with the limitations represented by this form of unique and complex network addresses, as regards handling of resource hierarchies.

The need of exclusivity of today's network addresses, relative to own network context, is a consequence of the need for operational joint action with complex resource hierarchies. With such an exclusivity principle, based on unique addresses, potentially enormous amounts of resources may be published and made available in a relatively simple manner within one and the same network context.

The disadvantages are, among other things, low address quality, lack of flexibility and fault tolerance, strong dependence on other components (for instance physical entities like computers, memory units, cables, distributors and other network equipment within a large electronic network structure), mechanisms, services and products in the network context, in addition to the difficulties implied by this form of network logical and hence arbitrary addressing strategy—as seen from a user perspective, i.e. the user's desire and intention about an as direct and/or immediate delivery of intended resource as possible, with a background in a requirement for address competence that is as low as possible, as described earlier.

Among other things, a relocation of a resource internally in a resource hierarchy will make such disadvantages visible, since this will imply that a previous network address (as well as information about delivery of resource using such a previous network address that has been propagated to other components, mechanisms, services and products attached to the network) is invalid, and resources will become permanently or temporarily unavailable, until a new network address has been propagated all the way, or a new resource has been given the same name and localisation.

Concrete examples of such a problem, are typically telephone numbers that are no longer in use by the resource, and inactive (“dead”) hypertext links. An ordinary user does not hold the address competence that is necessary in order to reach the intended resource, since today's network addresses cannot be expressed in accordance with intention. For instance, approximate or to a certain degree correctly written addresses will be invalid, or they will, by accident, lead to another resource than the resource that was originally intended by the user.

Attempts have been made to assist users who utilise addresses in electronic networks for delivery of a resource, by means of simpler and/or more meaningful addresses than the immediately available unique addresses within a network context.

For instance, telecommunication operators have offered short and/or distinct telephone numbers from particularly attractive number series in a national market, for instance to professional subscribers. Fewer digits and/or numeric similarity in address expressions will simplify memorisation for the user, and it will be simpler to find the associated network resource. An example of such a short and distinct telephone number is:

05050

Other operators have tried to cope with the need for remembering a unique electronic network address, by letting professional subscribers buy a special number from dedicated number series among further series of the network channel, which number can be communicated to users, and contains letters which together form one or several words in combination with a certain numerical prefix. One example of such a number can be the expression

800-NEW-PATENTS

Under the assumption that the keys on the user's telephone terminal have been marked with letters in a special order—typically ABC on numeral key 2, DEF on numeral key 3, GHI on numeral key 4 etc—the user will be able to memorise and find the network resource rather by focusing on the letters during keying of the address expression, than on the telephone number and the numerical, unique network address that the user actually keys in the first line user interface, namely 800-639-7283687.

The Domain Name System (DNS) that is used for internet, operates with a similar strategy, in which operators of associated network contexts—so-called domains—rather than communicating an exclusive numerical internet protocol address (IP address), may communicate a domain name, if desirable written both with letters and numerals, however, always belonging to a top level domain (TLD), made available through a public network, provided that the address statement is in accordance with a required, public address protocol within the superior network context in which the domain is included, and which will then often also include network-technical parameters.

Typically, domain names for internet in the www channel will be written:

http://www.newpatents.com

Through the DNS system, users may in a simpler manner remember an address necessary to make a query about delivery of typically the first and top layer in a specific resource hierarchy, in order to therefrom being able to for instance navigate, through graphically adapted user interfaces, resources or other mechanisms, up to an intended resource, rather than by memorising and keying (operating) unique and complex network addresses—as described previously.

New.net and RealNames have tried to add further functionality to the DNS system beyond the functionality originally offered within public network channel and protocol, for the purpose of making web addresses simpler to memorise:

New.net offers extensions attached to web addresses, valid for the same position in an address expression as the top domain level (TLD), through establishing an own, parallel infrastructure for addressing by using the channels of the DNS system. Typically, a New Net address will read:

www.newpatents.agents

However, the use of “.agents” in the same position in the address statement as the top domain level, requires installation of special software with the user, and possibly also with the user's internet provider (internet service provider—ISP), and hence is part of a private, proprietary and closed system, only seemingly within the public network context.

The matter is about the same for the RealNames addresses, where software is installed at a user, for in this manner—still by means of a private, proprietary and closed system—to be able to navigate in a simpler way toward network resources. Typically, a RealNames address is written in accordance with a brand or product name, for instance

Jeep

The present invention works along a strategy that is not quite dissimilar to the strategies in the respective examples that have just been mentioned, however with the substantial difference that the system and the method of the present invention is based on intentional addressing—already in the first line user interface, with richly and qualitatively stated addresses and queries for resources, in accordance with the user's intention about delivery of an intended resource from any level within the network context. This replaces the previous use that has been made possible sometimes previously, of partly meaningful addresses, provided that a corresponding, unique address has been offered associated with certain parts of the network context, and are even identical to the resource wish from the user, and it replaces also the previously known use of previous or consecutive further or external services, products or mechanisms, wherein the user's intention about delivery of an intended resource must be expressed in a meaningful manner before resources can thereafter be offered finally.

“Intentional” shall be taken to mean a functional move or action executed in accordance with intention, and not by chance.

“Intentional address” shall be taken to mean an address that is expressed richly, qualitatively and intentionally, in order to reach an intended resource.

Hence, the present invention aims at providing a solution to the problems that have been mentioned in the foregoing, and the solution appears by implementing a method and a system such as stated in the introduction, and characterised by the features appearing in the characteristic parts of the appended claims 1 and 8. Favourable embodiments of the invention appear from the appended dependent claims 2-7 and 9-11.

It is to be noted that the expression “resource query” in the claims may also comprise an address of a topical resource, or simply can be regarded as an address.

In the following, the various aspects of the invention shall be illuminated better by going through non-limitative embodiments, and in this connection it is referred to the appended drawings, in which

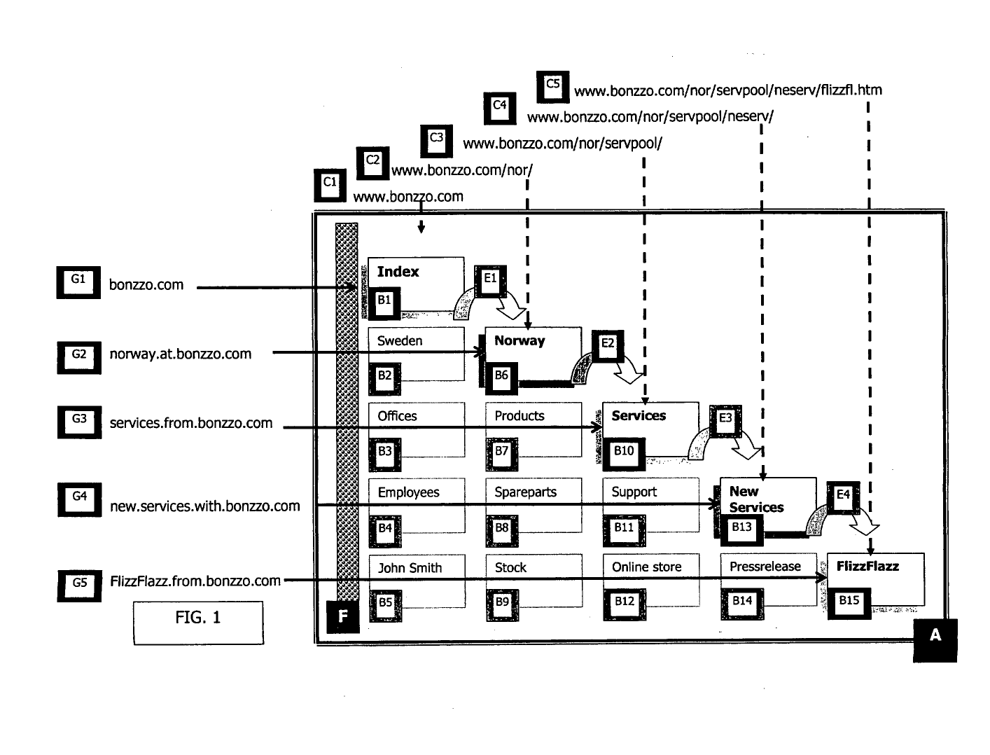

FIG. 1 shows a typical resource hierarchy and various ways of navigating therein,

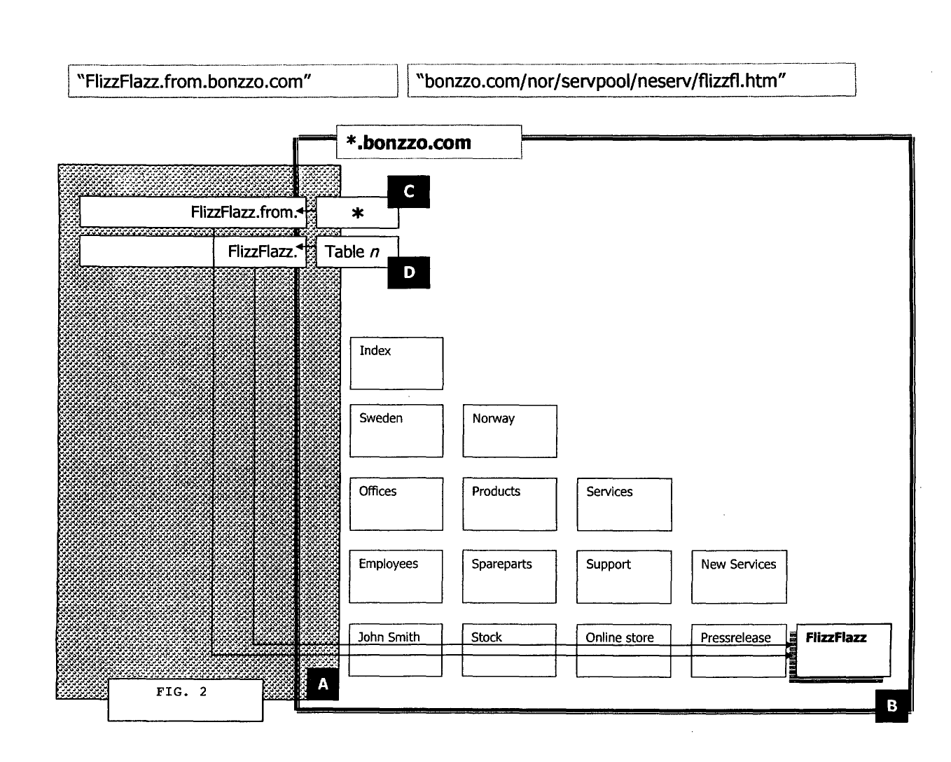

FIG. 2 shows the same resource hierarchy as in FIG. 1, however with a program-schematical implementation of a new dynamic layer for communication and handling, and

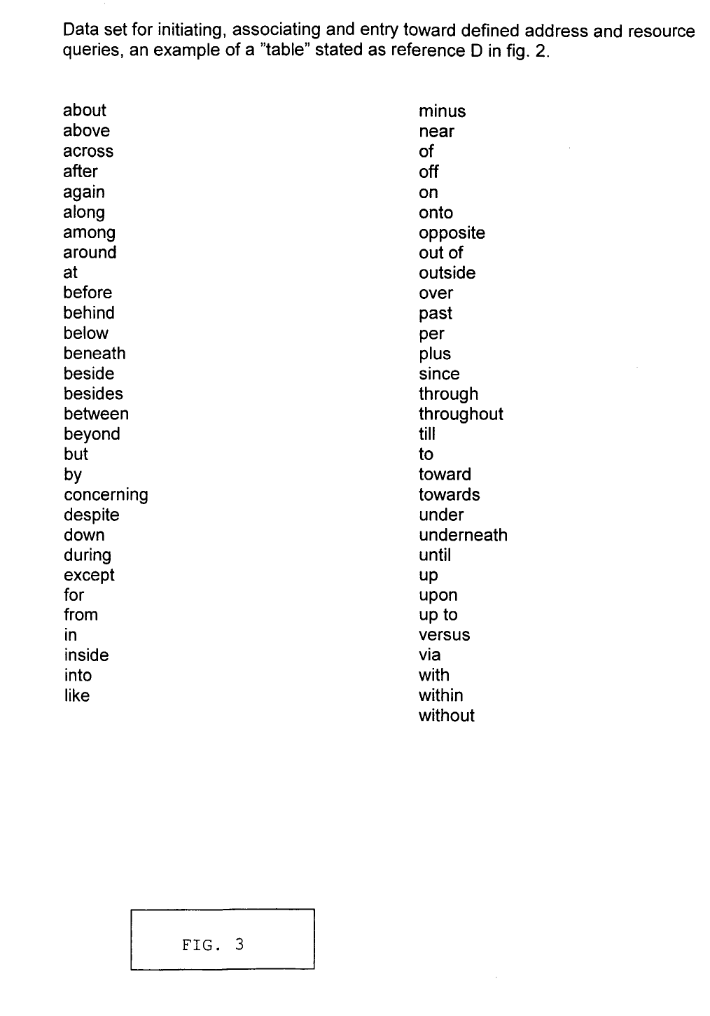

FIG. 3 shows a data set containing English prepositions.

FIG. 1 shows a typical resource hierarchy in a network context where an intended resource is available through today's unique network addresses, mechanism for navigation and finally made available through a type of intended address and a query for a resource that is made possible by a system and a method in accordance with the invention.

Specifically, FIG. 1 shows a typical resource hierarchy in a network context [A]—in this case a domain named “bonzzo” attached to top domain level “.com” in the www channel of the DNS system—with a set of resources [B1 to B15] that are available through the use of either typically unique network addresses in correspondence with today's standard [C1-C5], through the use of a known mechanism (in this case navigating stage-wise via a graphical user interface) [E1-E4], or through an example of such intended addressing and resource queries [G1-G5] that is made possible through the use of the dynamic layers for communication and handling [F] as described by the present invention.

Electronic networks and associated resource hierarchies contain available resources [B1-B15] suitable to comply with the user's desire for a source of help or information, through inter alia establishing communication and delivery of intended resource [here B15] prevailing for the user who has a desire to learn more about Flizz Flazz from Bonzzo.

Naturally, the user wishes to have his own desire for a source of assistance for information (i.e. resource) complied with as immediately and directly as at all possible, by being able to establish communication and transmission of intended resource as rapidly as possible.

The problem is that with today's unique network addresses [C1-C5], relatively extreme demands are made on the address competence of the user, to obtain such immediate and direct delivery of an intended resource.

A known technique that has already been mentioned previously, for assisting the user with regard to address competence problems, consists in offering a first layer of network context, typically an index page [B1] stated and made available through a somewhat less complex network address.

From this first layer of network context [B1], the user may thereafter navigate his way step-wise, by using for instance graphically adapted user interfaces for each step [E1, E2, E3 and E4] up to the intended resource [in this case, as previously mentioned B15], and in this manner the user may himself establish, through navigation, the necessary file localisation path in accordance with the network address.

This is of course quite resource-demanding for a user as regards time, material cost and ability to deliver the intended resource—implicitly or explicitly, and correspondingly for an operator—however experienced to a substantially larger degree, and especially associated with handling of the resources—one by one and/or together—in the network context.

This is where the present invention enters, which invention establishes the possibility, through one or several dynamic layers for communication and handling [F], to let the user employ an intentional address and make a query about delivery of a resource [G1-G5], for instance with a possibility for immediate delivery of the resource [B1, B6, B10, B13 and B15, respectively] as a consequence of the query.

A dynamic layer for communication and handling shall be taken to mean an active function range or sphere in which establishment of communication, exchange of information and handling of associated matters—for instance addresses and resources—takes place richly, qualitatively and intentionally. Materially, such a dynamic layer is realised in an operator-controlled, network-connected computer (server) with suitable programming.

Such delivery of an intended resource may occur via a detour through transmission to the user and his user interface, of the unique network address that belongs to the intended resource and is valid at any time, whereafter the resource is queried therefrom automatically or through uploading directly (if desirable, both without further intervention from the user) in the first line user interface, before the intended resource has been delivered to the same, further or other user interfaces of the user.

In such a manner, inter alia an intentional address and a query for a resource may be stated in the first line user interface in a high-quality, flexible and meaningful manner, like for instance:

norway.at.bonzzo.com

services.from.bonzzo.com

new.services.with.bonzzo.com

FlizzFlazz.from.bonzzo.com

rather than the unique addresses of today:

http://www.bonzzo.com/nor/

http://www.bonzzo.com/nor/servpool/

http://www.bonzzo.com/nor/servpool/neserv/

http://www.bonzzo.com/nor/servpool/neserv/flizzfl.htm

The delivery of the intended resource may just as well be external relative to the originally requested network context.

For instance, a dedicated network resource that offers assistance for locating resources—as previously described—may let the user make a query for the desired resource through his first line user interface, whereafter the intended resource can be delivered immediately and directly for instance alone, grouped or chained, rather than making the user first go to a dedicated network resource, there to express—in a new user interface and/or suitable mechanism—his intention for a desired resource, whereafter desired resources or “shortcuts” thereto are listed, prior to the user “navigating” his way to—finally—the intended resource(s).

In this manner, intentional addresses and queries for resources, for instance within dedicated resources in the internet, naturally be expressed also as follows:

Who.discovered.america.via.networkdomain1.tld

Mobilephonetests.from.networkdomain2.tld

Residences.at.between.1.and.2.millions.in.Oslo.1.at.networkdomain3.tld

FIG. 2 shows a program-schematic implementation of a new dynamic layer for communication and handling of intentional addresses and queries for resources, here still within a network context—a domain named “bonzzo” attached to top domain level “.com” in the www network channel of the DNS system.

Implementation of one or several dynamic layers for communication and handling takes place in connection with those parts of the address statement that the operator himself within the network context is able to read or handle prior to resource delivery, whereafter the operator, rather than delivering a resource in accordance with a directly indicated path, lets the address expressions be directed to dynamic layers for communication and handling, where inter alia the user's explicitly stated (intentional) address and query for a resource are interpreted with a view to uncovering the intention of the user, whereafter a choice of delivery of intended resource is made on the background of inter alia a set of rules (handling algorithms) and information associated with the resource, the user, the network channel, operator preference and similar parameters.

One example: an intentional address like “customer service at bonzzo.com” may, through a dynamic layer for communication and handling, deliver several different intended resources to a plurality of similarly different users.

A customer who writes this address—but in Norwegian language—may in a www channel arrive at a graphically adapted, Norwegian language resource in the domain bonzzo.com, which by means of for instance text, animation and images informs about the function of the customer centre, its opening times and how to get in contact with the customer centre through other channels.

The determination of the intended resource may in the last mentioned case have been made dependent on

1) qualities of the address statement that indicates a Norwegian language reference,

2) the query arrives through the www channel,

3) the user belongs to a public network context, and has no special privileges in relation to the context.

The same concrete content in a query from another user, might have resulted in a different intended resource.

Provided that an operator has the desire to, and the necessary resources to offer a better service quality to a user, the operator may—in the periods where the Norwegian customer service is closed—deliver an approximately similar English language resource to a customer service in the USA that is operated at that time—taking time zones into consideration.

In such a case, information regarding time and special operator preferences will be part of the determination of an intended resource.

If a pre-registered dealer, rather than a public customer, uses the same address, an operator may deliver as an intended resource, a resource specially dedicated for dealers. If the user turns out to make a query from within his own network context (i.e. the user is an employee with the operator), the operator may deliver as an intended resource one or several especially dedicated resources for employees.

FIG. 2 shows specifically how such dynamic layers for communication and handling [A] may be associated with the network context [B] and handle an appurtenant address and query for resources, completely [C] or partly [D] through program schematic manual or electronic implementation of necessary sets of data.

Naturally, there are no limitations regarding how rich, meaningful or correct such intentional addresses and resource queries may be stated, as regards the dynamic layer(s) for handling and communication, since the layer(s) will handle any address statement in the network context arrived at the operator, also from other network contexts—if necessary, other pseudo-protocol queries—than the originally associated network context.

Considering such an ability as mentioned regarding making a choice of resource with regard to for instance channel data, and the ability to handle also pseudo-protocol queries, an address example like

customer service at bonzzo.com

as described above, may work with a similar or identical address expression also in a WAP, SMS and MAIL channel, with a similar or identical immediate delivery of resource, or for that matter, differentiated if desirable.

In this manner, a user may employ the same intentional address, and consequently the same address competence, also in e.g. WAP to reach an intended resource within this network channel.

With the ability to handle also pseudo-protocol queries, the same intentional address—customer service at bonzzo.com—may also be utilized for delivery of an intended resource in other network channels where it is technically feasible to receive, from the user's first line user interface, a similar or identical address expression, for instance like within the SMS network channel.

In this manner, the invention enables use of one and the same address in three or more network channels.

It must be underlined that such a dynamic layer for communication and handling that makes possible richly expressed address and resource queries, naturally can be used to identify other concerns for the network context, suitable inter alia to lower the address competence demands for the user, for instance the user's language preference regarding delivery of resource, and in such an embodiment, eliminating the need of e.g. top domain level within a superior network context, which will make possible delivery of intended resource through the use of address expressions typically reading:

Flizz Flazz from Bonzzo

or for that matter with adaptations in other network contexts, in this case smarter “telephone numbers”:

Bonzzo customer service

The marketing manager of Bonzzo Norway

The prime minister

FIG. 3 shows a set of data implemented program schematically—manually or electronically—in order to make one particular type of traffic or address and resource queries be associated with a dynamic layer for communication and handling—in this case with the operator of the domain bonzzo.com

In this case, data have been chosen from the operator's desire to make possible only URL's written in approximately normal language through attachment of a dynamic layer for communication and handling with an opening toward a particular type of traffic concerning hostname1 in domain names; hostname1.bonzzo.tld

In particular, FIG. 3 shows every preposition within the English language. In some countries, a similar list of prepositions may have to contain adaptations due to letters outside the DNS system standard, which is English-based. An example is Norwegian, with æ, ø, å which must be replaced by a/ae, o/oe and a/aa. Some countries may also have more than one official language, and then prepositions from those official languages must be included.

Even with such a relatively limited set of data, and on the basis thereof, traffic or address and resource queries associated with a dynamic layer for communication and handling, address and resource queries can be stated meaningfully and in accordance with the intention of the user, using normal English or other language, and/or approximately normal, within complete network contexts, typically written as follows:

Norway.at.bonzzo.com

services.from.bonzzo.com

new.services.at.bonzzo.com

FlizzFlazz.from.bonzzo.com

Other, similarly limited sets of “language data” may make similar intentional addresses and resource queries possible within an operator's network context in different languages.

The invention provides numerous advantages. The most striking advantages for the user are perhaps a substantially higher service quality valid for network contexts through inter alia lower demands on address competence, fewer user interfaces and the possibility of immediate delivery of resource from a first line user interface, and consequently substantial time savings, even without having to be attached to private, proprietary and closed systems.

Further, the user may transfer his own already established address competence associated with intentional address and query for a resource such as described in the invention, also to other network channels and contexts and/or network channels and contexts to be introduced later, with a possibility for similar and/or identical intended resource delivery.

And finally in this connection, the user will experience that resources can be delivered to a much higher degree than previously, often even instead of a delivery of error reports or emphasizing of the user's lacking exact address competence, necessary for delivery of a resource.

The most striking one of the advantages of the present invention to the operator, is the possibility for more dynamic communication and handling.

Through implementation of such a layer for communication and handling, an operator of network context is provided with numerous new possibilities regarding strategies for delivery of a resource.

An intentional address and query for resource may for instance result in delivery of several different “intended resource”, depending on inter alia channel data accompanying the user. A public user may, such as previously mentioned, receive a publicly intended resource delivery—typically adapted brochure material—when he uses an intentional address, while an employee may receive in-company delivery of “intended resource”—typically product specifications, sales support material, and price data valid for the same product—when using the same intentional address and query for resource, as used by the public user.

Since intentional address and resource queries are handled isolated within the operator's own network context regarding the previously mentioned parts of the address statement—“server side”, it will be possible to reduce substantially inter alia the problems associated with propagation of a unique new address and/or resource localisation path, and consequently the strong dependence today on other elements, mechanisms, services and products in the network context.

Meta-data regarding delivery of a resource in associated network contexts may, through the method and the system described by the present invention, if desirable always be valid, even if resources are moved internally in resource hierarchies, since “propagation” takes place “server side” in the cause of only milliseconds.

Previously incorrectly keyed addresses and resource queries may be converted to a delivery of resource instead of e.g. error reports, since intentional address and resource queries make it possible to uncover the user's expectation and/or desire for an intended resource delivery within a network context. Hence, a possibility is provided for assisting the user to reach a minimum of information at all events—if necessary, contact data to the right person to contact.

Somewhat less conspicuous are the advantages that are a consequence of the fact that substantial resource savings for the operator and his network context can be achieved through potentially considerably lowered demands for processor power, bandwidth and other network-determined infrastructure, for similar and/or better qualitative and quantitative resource delivery as compared to today. The reason is that resource-demanding uploads of mechanisms and data for instance associated with graphically adapted user interfaces for the intermediate sessions which the user today must navigate through prior to achieving the intended resource, are eliminated completely or partly as a consequence of the present invention.

At the same time, any intentional address queried toward a domain will represent an immediate value, also independent of the delivery of the intended resource, with the possibility to interpret the user's desire, for instance for customer relation purposes, which is a possibility and a value that the unique addresses of today are not able to deliver at a similar degree.

Further, intentional addressing and resource queries render possible establishing extremely flexible and focused publication solutions (if desirable, available in a similar manner is several network channels), where the user receives delivery of resources, either “pages”, “headlines”, “section headlines”, “articles”, “tables”, definitions or for that matter “ticker data” associated with for instance extremely focused content—without other content than the queried intended content.

Summing up, the present invention will be able to implement a protocol extension relative to the standardised DNS system, in DNS servers at operators utilizing the invention. Thereby, use of normal language syntax is made possible as valid network addresses via TCP/IP i.e.:

that.new.car.from.toyota.com

instead of the topical address of today, namely

http://www.toyota.com/html/shop/vehicles/matrix/

investor.relations.at.ericsson.com

instead of today's address, which is

http://www.ericsson.com/investors/

inspiron.8200.from.dell.com

instead of the address of today, which is

http://www.dell.com/us/en/dhs/offers/specials3xspecial62.htm

where.do.I.find.pictures.of.brad.pitt.at.aj.com

instead of the present topical address, which is

http://www.aj.com/main/askjeeves.asp?ask=where+do+I+find+pictures+of+brad+pitt %3F&o=0&x=9&y=4

The technique of the present invention offers to organisations that have invested in a brand/mark, a possibility to offer their customers, partners, employees and other users “online” network addressing within their own domain, with addresses that:
are relevant with regard to content/resource
are simpler to memorize—mnemonic addresses
deliver specific content to users on request.

Further, the addresses will work in the same manner in all TCP/IP channels, the most commonly used ones being www and WAP. An SMS extension is also available, and enables users to utilize the same address for queries also in the SMS channel.

For instance, a user may key a query for information and/or a service in the www or WAP browser address line in accordance with ordinary language syntax, for instance:

thinkpad.from.ibm.com

The special and relevant page regarding the IBM product line for “thinkpad” at IBM.com (namely, the page http://www.pc.ibm.com/europe/thinkpad/index.html?no) will be delivered immediately, and the user will then be able to read content concerning the IBM “Thinkpad” product line as a first download to the web browser in the course of seconds, instead of obtaining this page after the average six minutes of “manual” search performed by the user, through WAP indexes and their extended link hierarchy, or through the graphic www interface at www.ibm.com, such as is commonly done today.

The result is that users save minutes per search for specific content, and in this manner they will experience a quite tangible increase of service level for this domain service. Hence, through the present invention, loyalty and business advantages can be built, to favour operators who use the present invention.

An ordinary rule is that, when using the present invention, delivery of specific resources to www and WAP users will be more than fifteen times as rapid as any application or address protocol available on the market today.

It must be emphasized that the above description is based on a discussion of embodiments and is illuminated by the appended drawings, but the scope of the present invention should not be limited by these exemplary embodiments and drawings, but only by the independent claims following hereafter.

1. A method for rapid provision of desired resources for users in a data network, characterized in that
a user states a resource query in rich language in a first line user interface attached to the data network, intentionally and in accordance with own desire for intended resource delivery,
whereafter at least one layer for dynamic communication and handling, implemented at a network context operator, receives, reads and processes said intentional resource query in order to uncover the intention of the user, through processing of the resource query in accordance with user specific and query specific information as well as special handling algorithms,
whereafter said layer establishes a connection in the data network directly between the user and the specific address of the intended resource, on basis of the uncovered intention.

2. The method of claim 1, characterized in that the user states the intentional resource query in an address line in a browser for internet, within the framework of a protocol that leads the resource query to said operator, typically by using a domain name belonging to the operator.

3. The method of claim 1, characterized in that the user states the intentional resource query in a user interface in which the user keys numbers for telecommunication.

4. The method of claim 1, characterized in that the user states the intentional resource query in an SMS channel.

5. The method of claim 1, characterized in that the user expresses the intentional query in a WAP channel.

6. The method of claim 1, characterized in that said at least one layer for dynamic communication and handling, after uncovering the user's intention and translation of said intention to the unique address of the intended resource in the data network, transmits the address to the user's first line user interface which then uploads the intended resource directly, without further intervention from the user.

7. The method of claim 1, characterized in that said at least one layer for dynamic communication and handling, after uncovering the intention of the user and translation of said intention to the unique address of the intended resource in the data network, makes a transfer to this address directly.

8. A system for rapid provision of desired resources for users in a data network, said data network comprising, in addition to network connections, network nodes and routing units,
system elements in the form of
user terminals with ability to establish a first line user interface between a user and the data network, and
operators of network context, with ability to respond to queries from user terminals by returning desired resources thereto,
said system being characterized in that
it further comprises at least one layer for dynamic communication and handling of richly stated resource queries, said layer being implemented at a network context operator, and
in that said layer is operative to uncover a user's intention with a richly stated resource query in a first line user interface, by processing said query in accordance with user specific and query specific information as well as special handling algorithms, and to provide a connection in the data network directly between the user and the specific address of said intended resource, on the basis of said uncovered intention.

9. The system of claim 8, characterized in that said at least one layer for dynamic communication and handling is implemented in a server at the operator.

10. The system of claim 8, characterized in that said at least one layer is operative to put the uncovered intention of a user in relation to resources at the operator in question.

11. The system of claim 8, characterized in that said at least one layer is operative to relate user intentions to resources at other operators.
